(19) United States
(12) Patent Application Publication
(10) Pub. No.: US 2005/0273796 A1
(43) Pub. Date: Dec. 8, 2005

(54) Mechanism for facilitating alignment of tray in optical disc drive

(75) Inventors: Chi-Chih Tseng, Hsinchu (TW); Te-Hsiung Lai, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/145,740

(22) Filed: Jun. 6, 2005

(30) Foreign Application Priority Data
Jun. 8, 2004 (TW) 093116457

(51) Int. Cl. G11B 17/03; G11B 17/04; G11B 33/02

(52) U.S. Cl. 720/647; 720/601

(57) ABSTRACT

A mechanism for facilitating alignment of a tray in an optical disc drive includes a first engaging member, a second engaging member and a flexible member. The tray is hidden in a slot of the optical disc drive with the covering of a tray door and coupled to the tray door via a tray mount. The first engaging member is arranged at a side wall of the slot. The second engaging member is arranged at a side wall of the tray door for engaging with the first engaging member when the tray is received in the slot. The flexible member is arranged at a side of the tray mount opposite to the tray door. The flexible member is deformed when the tray is retracted into the slot, and restores to urge the tray mount against the tray door when the tray is ejected from the slot.

### FIELD OF THE INVENTION

The present invention relates to an aligning mechanism, and more particularly to a mechanism for facilitating alignment of a tray in an optical disc drive.

### BACKGROUND OF THE INVENTION

When an optical pickup head of an optical disc drive operates, the light emitted by a light source such as a laser diode is focused on an optical disc supported by a tray through an object lens of the optical pickup head, and the light reflected by the optical disc in the tray is transmitted to a light sensor to realize information from the disc.

Referring to FIG. 1, a tray eject/load mechanism of a typical optical disc drive is shown. The tray eject/load mechanism includes a tray 12, a tray door 13 and a tray eject/load button 14 arranged in/on the main body 11 of the optical disc drive 10. For loading an optical disc, the tray eject/load button 14 is pushed to automatically transmit the tray 12 out of the main body 11 from a rectangular opening 16. After the optical disc is positioned in the open tray 12, the tray eject/load button 14 is pushed again to retract the tray 12 with the optical disc into the main body 11 from the opening 16.

Ideally, whenever the tray 12 is received inside the main body 11, the tray door 13 perfectly matches the opening 16 so as to configure a smooth surface in the front of the main body 11. Sometimes, however, the tray 12 is not well aligned with the opening 16 because of accumulated tolerance resulting from the components involved in the ejecting/loading operations of the tray. Since the tray door 13 is inflexibly attached to the tray 12, once the eject/load path L1 of the tray 12 is somewhat deviated, the tray door 13 will fail to completely enter and perfectly integrate with the optical disc drive 10. Under this circumstance, not only the appearance of the optical disc drive would become aesthetically unpleasing, but the reading operation might not be adversely affected. On the other hand, if the tolerances of associated parts of the tray eject/load mechanism are lowered to avoid the misalignment mentioned above, the yield of products would be lowered and the cost increases.

### SUMMARY OF THE INVENTION

The present invention provides a mechanism for facilitating alignment of a tray in an optical disc drive so that no strict tolerance is required to match the tray and the opening.

The present invention, provides a mechanism for facilitating alignment of a tray in an optical disc drive when the tray is hidden in a slot of the optical disc drive with the covering of a tray door. The tray is coupled to the tray door via a tray mount. The mechanism comprises a first engaging member, a second engaging member and a flexible member. The first engaging member is arranged at a side wall of the slot. The second engaging member is arranged at a side wall of the tray door for engaging with the first engaging member when the tray is received in the slot.

In an embodiment, the first engaging member is a tapered trench structure and the second engaging member is a tapered protrusion structure having shape and size in conformity to the tapered protrusion structure. Optionally but preferably, the tapered trench structure and the tapered protrusion structure are wedge-shaped.

The flexible member is arranged at a side of the tray mount opposite to the tray door. The flexible member is deformed when the tray is retracted into the slot, and restores to urge the tray mount against the tray door when the tray is ejected from the slot. In an embodiment, at least one screw member is used for coupling the tray mount to the tray door by penetrating through a hole of the tray mount and secured in a recess of the tray door. Preferably, a diameter of a screw head of the screw member is greater than that of the hole so as to prevent the tray mount from escaping from the tray door, but a diameter of a screw body of the screw member is less than that of the hole so as to allow the tray mount to be slightly shifted relative to the tray door. The flexible member can be a spring element sheathed with the screw member and disposed between the screw head and the tray mount. Optionally but preferably, a cushion element is disposed between the tray mount and the tray door.

The present invention also relates to a mechanism comprising first and second wedge-shaped trench structures, first and second wedged-shaped protrusion structures and a flexible member. The first and second wedge-shaped trench structures are disposed at opposite side walls of the slot, respectively. The first and second wedged-shaped protrusion structures are disposed at bilateral sides of the tray door and mate with the first and second wedge-shaped trench structures, respectively. Preferably, the first and second wedge-shaped trench structures and first and second wedged-shaped protrusion structures are inwardly tapered. The flexible member is urged by the tray mount when the tray is retracted into the slot, and restores to urge the tray mount against the tray door when the tray is ejected from the slot.

The present invention further relates to a mechanism comprising first and second inwardly tapered trench structures, first and second inwardly tapered protrusion structures and a flexible member. The first and second inwardly tapered trench structures are disposed at opposite side walls of the slot, respectively. The first and second inwardly tapered protrusion structures are disposed at bilateral sides of the tray door and mate with the first and second inwardly tapered trench structures, respectively. The flexible member is urged by the tray mount when the tray is retracted into the slot, and restores to urge the tray mount against the tray door when the tray is ejected from the slot.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a tray eject/load mechanism of a typical optical disc drive;

FIG. 2 is a schematic front view of an optical disc drive according to a preferred embodiment of the present invention;

FIG. 3 is a cross-sectional view of the optical disc drive of FIG. 2 taken along the B-B line;

FIG. 4 is a partially enlarged view of the coupling mechanism P2 of FIG. 3;

FIG. 5A is a cross-sectional view of the optical disc drive of FIG. 2 taken along the A-A line;

FIG. 5B is a partially enlarged view of the portion P4 of FIG. 5A;

FIG. 6A is a right perspective view of the optical disc drive cut along the C-C line of FIG. 2, in which the tray door and tray mount are detached from the tray;

FIG. 6B is a right perspective view of the optical disc drive cut along the C-C line of FIG. 2, in which the tray door and tray mount are combined with the tray; and

FIG. 7 is a partially enlarged view of the engaging mechanism P1 of FIG. 3.

### DETAILED DESCRIPTION OF THE PREFERRED EMBODIMENT

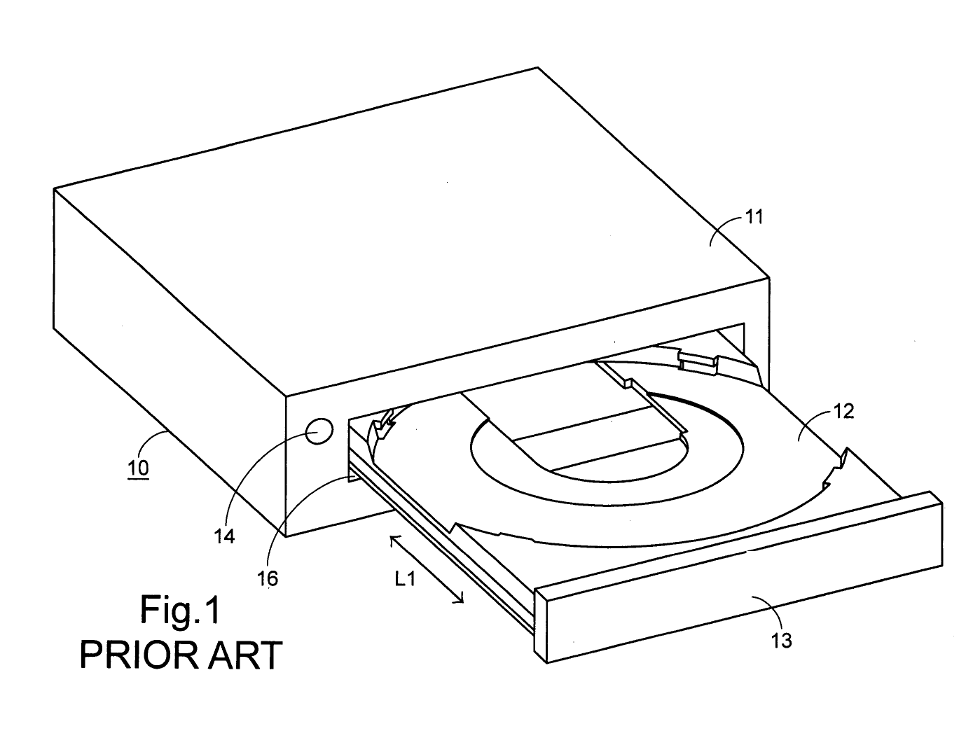

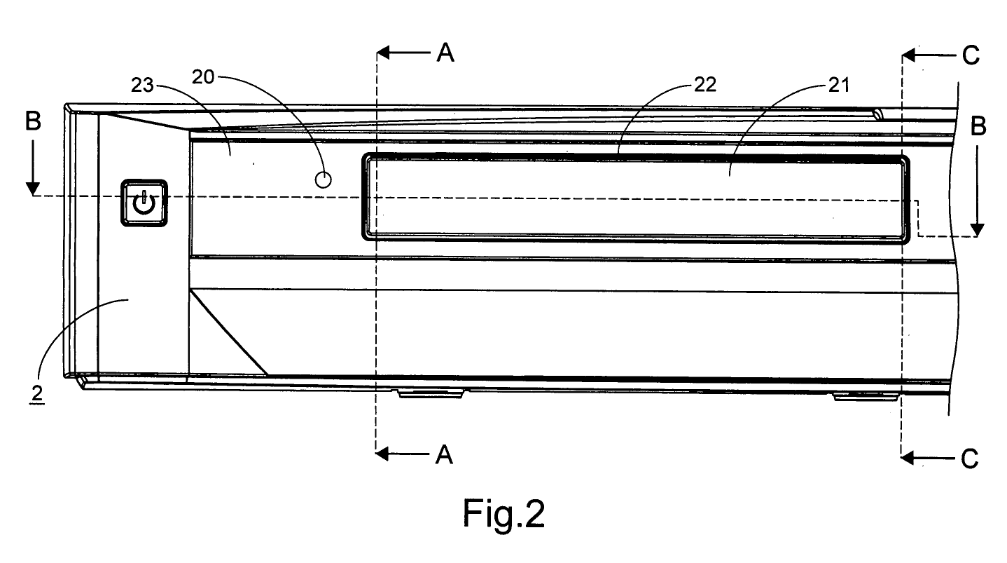

Hereinafter, an embodiment of a mechanism for facilitating alignment of a tray in an optical disc drive according to the present invention will be illustrated. Referring to FIG. 2, it is illustrated that a tray is hidden in a slot 22 of the optical disc drive with the covering of a tray door 21. For loading an optical disc, a tray eject/load button 20 arranged on the main body 23 of the optical disc drive 2 is pushed to automatically transmit the tray out of the main body 23 from the slot 22 (see FIG. 1 for reference). After the optical disc is positioned in the open tray, the tray eject/load button 20 is pushed again to retract the tray 22 with the optical disc into the main body 23 from the slot 22.

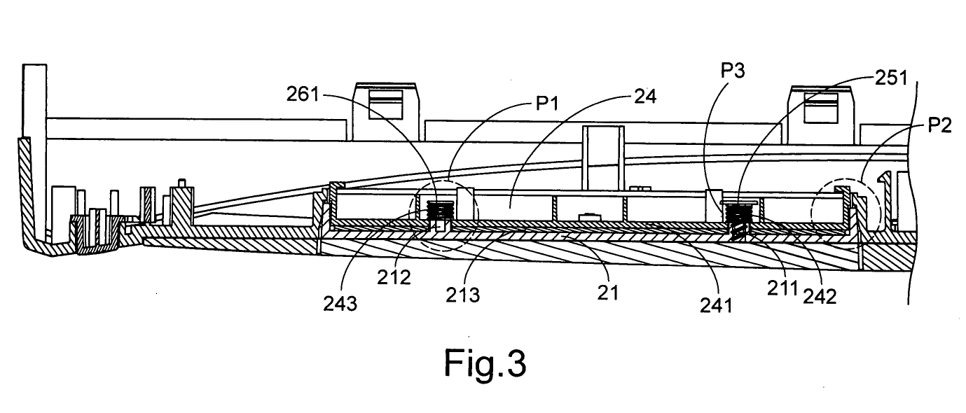

FIG. 3 is a cross-sectional view of the optical disc drive 2 of FIG. 2 taken along the B-B line. As shown, the tray 24 securely engages with a tray mount 241, and the tray mount 241 is coupled to the tray door 21 with coupling means (see portions P1 and P3). A spring element 242 is sheathed with the screw member 211, and disposed between the screw head 251 and the tray mount 241 for urging the tray mount 241 against the tray door 21. Likewise, another spring element 243 is sheathed with the screw member 212, and disposed between the screw head 261 of the screw member 212 and the tray mount 241 for keeping well coupling of the tray mount 241 to the tray door 21. In addition, a sponge layer 213 is disposed between the tray mount 241 and the tray door 21 as a cushion. When the tray 24 is retracted into the slot 22, the tray door 21 will engage with the main body 23 of the optical disc drive 2 via engaging means (see portion P2).

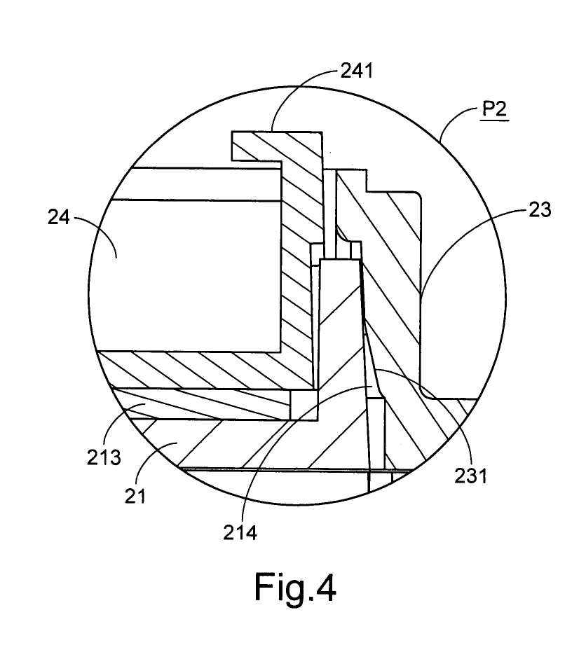

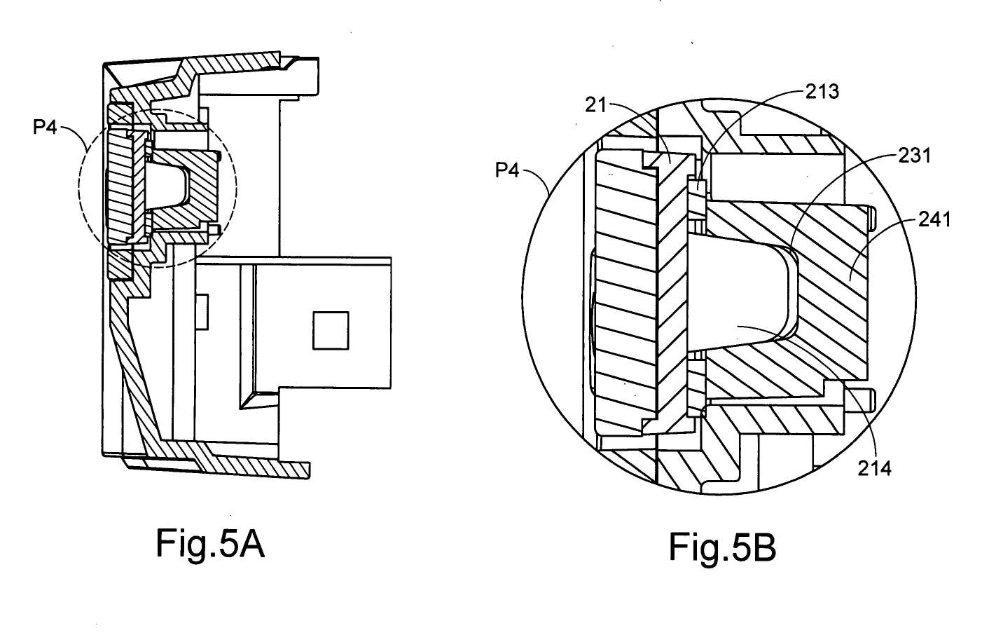

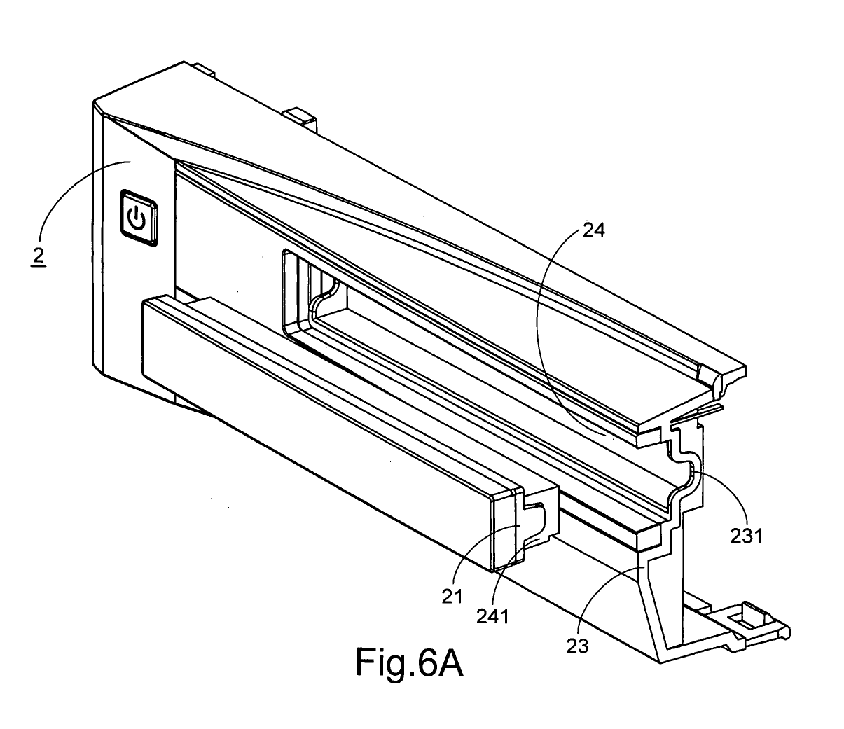

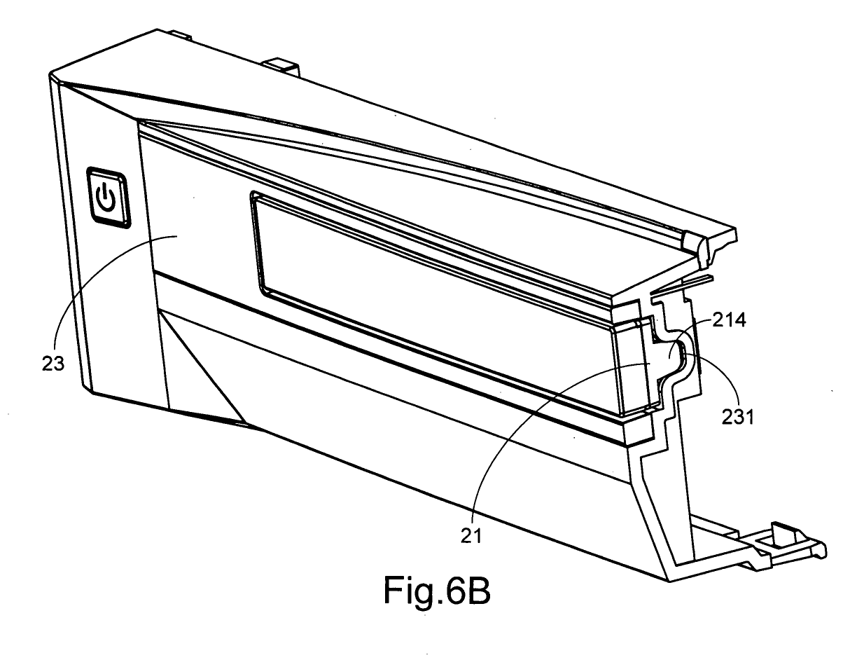

Referring to FIGS. 4, 5A, 5B, 6A and 6B, which illustrate the engaging means in various views, the engaging means includes a wedge-shaped and inwardly tapered trench structure 231 arranged on a side wall of the slot 22, and a wedged-shaped and inwardly tapered protrusion structure 214 arranged at a side wall of the tray door 21. The protrusion structure 214 has shape and size in conformity to the trench structure 231 so as to be engageable with the trench structure 231 when the tray 24 is received in the slot 22. The wedge shape allows the protrusion structure 214 to be guided into the trench structure 231 smoothly and automatically aligns the tray door 21 in the optical disc drive in an X direction (the height direction) and a Z direction (the depth direction). Further, the inwardly tapered configuration also allows the protrusion structure 214 to be guided into the trench structure 231 smoothly and automatically aligns the tray door 21 in the optical disc drive in a Y direction (the width direction). Similar engaging means is provided on the opposite side wall of the slot 22. Due to the well guided engagement of the protrusion structure 214 and the trench structure 231, the tray door 21 matches the opening of the slot 22 and configures a smooth surface in the front of the main body 23 when the tray 24 is received in the slot 22.

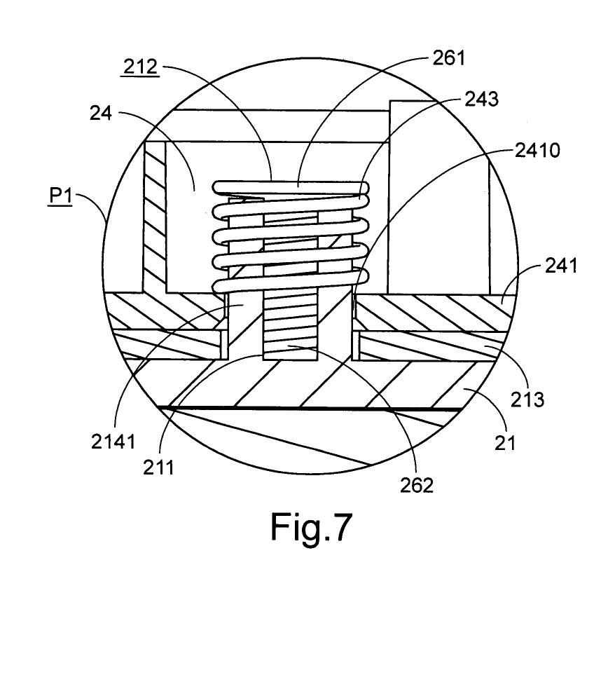

In FIG. 7, which is an enlarged view of the portion P1 of FIG. 3, the coupling of the tray mount 241 to the tray door 21 with the screw member 212 is shown. The tray door 21 has a raised portion 2141 penetrating through a hole 2410 of the tray mount 241. The outer diameter of the raised portion 2141 is a little smaller than the diameter of the hole 2410 so that the tray mount 241 can slightly move relative to the tray door 21 in the Y (width) direction and X (height) direction, thereby cooperating with the engaging means, e.g. P2, to make adjustment when the eject/load path of the tray is somewhat deviated. The screw body 262 of the screw member 212 is secured into a threaded recess 211 of the tray door 21 and sleeved thereon the spring element 243. The diameter of the screw head 261 of the screw member 212 is made greater than that of the hole 2410 of the tray mount 241 to prevent the tray mount 241 from escaping from the tray door 21. When the tray 24 is retracted into the slot 22, the tray door 21 will engage with the main body 23. If the tray 24 is retracted to an extent greater than usual, the tray mount 241 will slightly separate from the tray door 21 so that the spring member 243 will be urged by the tray mount 241 and thus deformed. Subsequently, when the tray 24 is ejected from the slot 22, the screw member 243 will be released and restore to urge the tray mount 241 against the tray door 21 to keep well coupling of the tray mount 241 and tray door 21. The working principle and function of the other coupling means (P3) including the screw 211 and spring 242 are similar to that illustrated in FIG. 7.

To sum up, according to the present invention, the tray door and tray mount can be shifted relative to each other. Therefore, even if the retraction path of the tray is deviated, the engaging means of the present mechanism will guide the tray door to configure a smooth surface in the front of the main body. Further, since the tray door is coupled to but separable from the tray mount, the smooth surface configured by the tray door and the front panel of the optical disc drive can still be assured even if the tray and the tray mount are over-retracted. On the other hand, the flexible member, e.g. the spring element, will keep well coupling of the tray mount and the tray door once the retraction force is removed. From the above illustration and description, it is understood that no strict tolerance is required to avoid the misalignment of elements according to the present invention so as to increase the yield of products.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A mechanism for facilitating alignment of a tray in an optical disc drive, the tray being hidden in a slot of the optical disc drive with the covering of a tray door and coupled to the tray door via a tray mount, and said mechanism comprising:
a first engaging member arranged at a side wall of the slot;
a second engaging member arranged at a side wall of the tray door for engaging with said first engaging member when the tray is received in the slot; and
a flexible member arranged at a side of the tray mount opposite to the tray door, said flexible member being deformed when the tray is retracted into the slot, and restoring to urge the tray mount against the tray door when the tray is ejected from the slot.

2. The mechanism according to claim 1 wherein said first engaging member is a tapered trench structure and said second engaging member is a tapered protrusion structure having shape and size in conformity to said tapered protrusion structure.

3. The mechanism according to claim 2 wherein said tapered trench structure and said tapered protrusion structure are wedge-shaped.

4. The mechanism according to claim 1 further comprising at least one screw member for coupling the tray mount to the tray door by penetrating through a hole of the tray mount and secured in a recess of the tray door.

5. The mechanism according to claim 4 wherein a diameter of a screw head of said screw member is greater than that of said hole so as to prevent the tray mount from escaping from the tray door, but a diameter of a screw body of said screw member is less than that of said hole so as to allow the tray mount to be slightly shifted relative to the tray door.

6. The mechanism according to claim 5 wherein said flexible member is a spring element sheathed with said screw member and disposed between said screw head and the tray mount.

7. The mechanism according to claim 6 further comprising a cushion element disposed between the tray mount and the tray door.

8. A mechanism for facilitating alignment of a tray in an optical disc drive, the tray being hidden in a slot of the optical disc drive with the covering of a tray door and coupled to the tray door via a tray mount, and said mechanism comprising:
first and second wedge-shaped trench structures disposed at opposite side walls of the slot, respectively;
first and second wedged-shaped protrusion structures disposed at bilateral sides of the tray door and mating with said first and second wedge-shaped trench structures, respectively; and
a flexible member urged by the tray mount when the tray is retracted into the slot, and restoring to urge the tray mount against the tray door when the tray is ejected from the slot.

9. The mechanism according to claim 8 wherein said first and second wedge-shaped trench structures and first and second wedged-shaped protrusion structures are inwardly tapered.

10. The mechanism according to claim 8 further comprising at least one screw member for coupling the tray mount to the tray door by penetrating through a hole of the tray mount and secured in a recess of the tray door.

11. The mechanism according to claim 10 wherein a diameter of a screw head of said screw member is greater than that of said hole so as to prevent the tray mount from escaping from the tray door, but a diameter of a screw body of said screw member is less than that of said hole so as to allow the tray mount to be slightly shifted relative to the tray door.

12. The mechanism according to claim 11 wherein said flexible member is a spring element sheathed with said screw member and disposed between said screw head and the tray mount.

13. The mechanism according to claim 12 further comprising a cushion element disposed between the tray mount and the tray door.

14. A mechanism for facilitating alignment of a tray in an optical disc drive, the tray being hidden in a slot of the optical disc drive with the covering of a tray door and coupled to the tray door via a tray mount, and said mechanism comprising:
first and second inwardly tapered trench structures disposed at opposite side walls of the slot, respectively;
first and second inwardly tapered protrusion structures disposed at bilateral sides of the tray door and mating with said first and second inwardly tapered trench structures, respectively; and
a flexible member urged by the tray mount when the tray is retracted into the slot, and restoring to urge the tray mount against the tray door when the tray is ejected from the slot.

15. The mechanism according to claim 14 further comprising at least one screw member for coupling the tray mount to the tray door by penetrating through a hole of the tray mount and secured in a recess of the tray door.

16. The mechanism according to claim 15 wherein a diameter of a screw head of said screw member is greater than that of said hole so as to prevent the tray mount from escaping from the tray door, but a diameter of a screw body of said screw member is less than that of said hole so as to allow the tray mount to be slightly shifted relative to the tray door.

17. The mechanism according to claim 16 wherein said flexible member is a spring element sheathed with said screw member and disposed between said screw head and the tray mount.

18. The mechanism according to claim 17 further comprising a cushion element disposed between the tray mount and the tray door.
